(19) United States
(12) Patent Application Publication
(10) Pub. No.: US 2026/0166561 A1
(43) Pub. Date: Jun. 18, 2026

(54) BULK WASTE COMPACTION APPARATUS

(71) Applicant: Bucher Municipal Pty Ltd, Clayton North VIC (AU)

(72) Inventors: Andrew Mitchell, Clayton North (AU); Florin Voicu, Clayton North (AU)

(21) Appl. No.: 19/123,715

(22) PCT Filed: Oct. 27, 2023
(86) PCT No.: PCT/AU2023/051089

§ 371 Date: Apr. 23, 2025

(30) Foreign Application Priority Data
Oct. 28, 2022 (AU) 2022903213

(51) Int. Cl. B02C 18/14; B02C 18/00; B02C 18/18; B02C 18/22

(52) U.S. Cl. CPC B02C 18/141; B02C 18/0092; B02C 18/144; B02C 18/186; B02C 18/2291; B02C 2018/188

(57) ABSTRACT

The invention concerns a bulk waste compaction apparatus including a material-receiving hopper, an elongated trough, and an auger mounted to rotate in and drive material axially lengthwise of the elongated trough, including an opening through which the material is driven forward by the auger, wherein the auger includes an auger flight, the auger flight having a plurality of auger teeth projecting radially outwardly therefrom and a plurality of fixed teeth provided at or adjacent to the opening and projecting radially inwardly towards the auger. The apparatus may include a bulk waste container to receive material that has been impacted by the interaction between the auger teeth and the fixed teeth, which may be separable from the rest of the apparatus.

### FIELD OF THE INVENTION

The present invention concerns a bulk waste compaction apparatus.

### BACKGROUND OF THE INVENTION

Various types of bulk waste compaction equipment have been developed, including devices to compact waste material such as recyclable waste material.

Waste compaction is beneficial, allowing more waste to fit into the same receiving space. Compacting waste on or after collection allows more waste to fit inside the collection vehicle or other collection equipment, making downstream material handling operation more efficient (for example, meaning fewer downstream handling operations are required). Different ways to process bulk waste material have been developed in order to compress and reduce volumes of waste materials through hydraulic, mechanical or pneumatic force, which has the effect of forcing air and fluids out of the solid material. Such solutions include pendulum compactors, ram compactors, rotary and hammermill shredders and auger compactors.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In accordance with the present invention, there is provided a bulk waste compaction apparatus including a material-receiving hopper, an elongated trough, and an auger mounted to rotate in and drive material axially lengthwise of the elongated trough, including an opening through which the material is driven forward by the auger, wherein the auger includes an auger flight,
the auger flight having a plurality of auger teeth projecting radially outwardly therefrom and
a plurality of fixed teeth provided at or adjacent to the opening and projecting radially inwardly towards the auger.

In this way, waste material that is driven by the auger through the opening can be impacted between the auger teeth and the fixed teeth, resulting in cutting and/or deforming of the material and increasing or factilitating compaction of the resulting waste stream.

Preferably, the auger extends through the opening and the auger teeth are disposed on the auger flight for at least an axial distance both forward and rearward of the opening.

Preferably, both the opening and the auger flight (when viewed in transverse projection) are both circular, their respective diameters resulting in the fixed teeth and the auger teeth passing relatively close to one another as the auger rotates.

Preferably, the elongated trough is shaped to direct introduced waste material to and contain said material in a part of the trough adjacent to the auger flight.

It will be understood that the auger teeth and the fixed teeth may take any form, provided that they function when interacting to cut and/or deform items within the waste material. Ideally, the auger teeth are cutter teeth, each tooth having a generally sawtooth shaping, an acute edge and/or a leading point. This assists with the teeth snagging, tearing, cutting and/or puncturing waste items.

The fixed teeth may be provided on arcuate fixed tooth sections, each section providing a number of fixed teeth, such that multiple such sections can be mounted to the apparatus to partially or wholly encompass the circumference of the opening.

The apparatus may include a further plurality of fixed teeth axially spaced from the plurality of fixed teeth. This provides a second opportunity for impacting waste material between the auger teeth and the fixed teeth, further increasing facilitation of compaction of the waste stream.

The apparatus may include one or more retention elements adjacent to or downstream of the fixed teeth and mounted to restrain the axial and/or rotational movement of waste material, in order to increase the likelihood of the waste material being impacted between the auger teeth and the fixed teeth.

For example, one or more strainer elements may be provided beyond and adjacent to the downstream extent of the auger, configured to retain waste items greater than a certain size. This can be of particular importance when the waste material includes plastic bottles or other containers, as only items that have been cut or deformed are able to readily continue their downstream travel.

Alternatively or in addition, one or more radially extending retainer elements may be provided, configured to retain waste material against rotation. This assists in ensuring that the material will be impacted by the auger teeth as the auger rotates.

The apparatus preferably includes a bulk waste container to receive material that has been impacted by the interaction between the auger teeth and the fixed teeth. The bulk waste container may be separable from the rest of the apparatus, in order to convey the compacted waste to a receiving or subsequent processing station.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 shows a stationary compactor in accordance with the present invention, with FIG. 1A illustrating an alternative form;

FIG. 2 shows details of the auger compactor head of the apparatus of FIG. 1, including a plan view (top left), longitudinal section A-A thereof, transverse section B-B and detail C of section B-B;

FIGS. 3, 3A show further detail of the auger compactor of FIG. 2, including the outlet portion of the apparatus;

FIG. 4 illustrates a further embodiment of the auger compactor, including additional detail of the outlet portion;

FIG. 5A depicts a further embodiment of the auger compactor;

FIG. 5B shows a longitudinal section view of the auger compactor of FIG. 5A, including section detail B (of the outlet portion);

FIG. 6A illustrates yet a further embodiment of the auger compactor; and

FIG. 6B shows a longitudinal section view of the auger compactor of FIG. 6A, including section detail D (of the outlet portion).

### DETAILED DESCRIPTION OF THE EMBODIMENTS

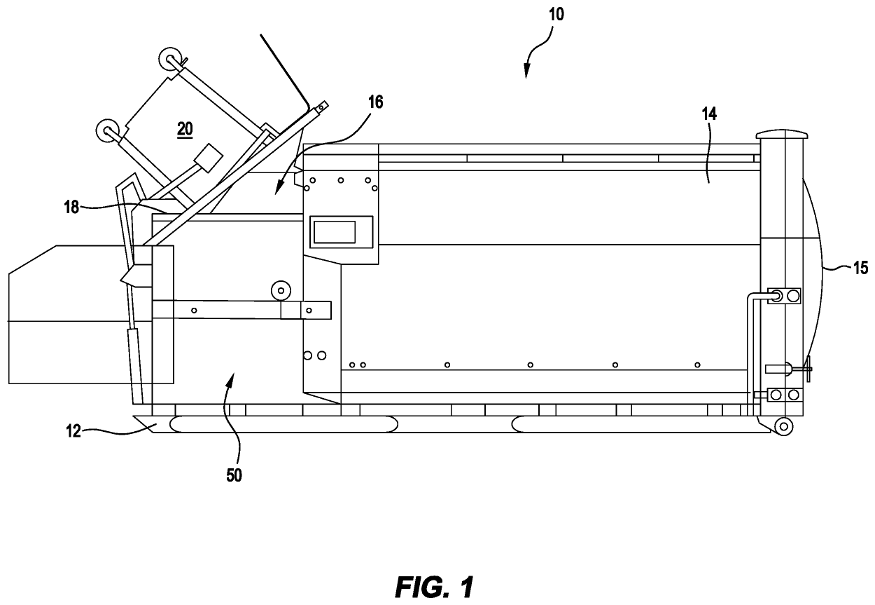

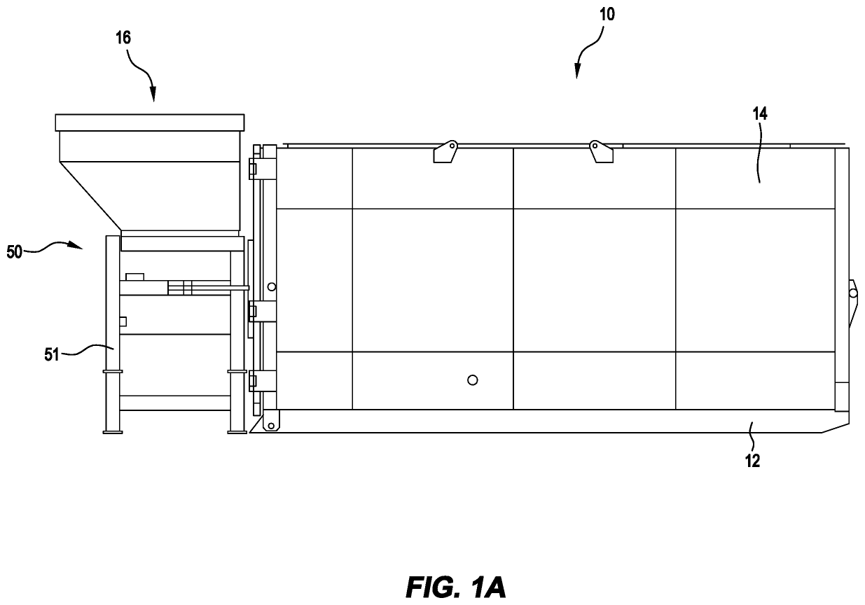

The stationary compactor 10 of FIG. 1 is designed for compacting large volumes of dry waste such as dry general waste, plastic and other containers, paper, cardboard and timber. The aim of such processing is significant volume reduction, saving in collection and transport costs for waste and recycling services. Whilst the embodiments of the invention described and illustrated herein are static compactors, it will be understood that the invention could also be provided in a vehicle, such as a garbage collection and compaction truck.

The auger compactor 10 is mounted on support rails 12 and includes a compacted waste receiving container 14 of elongated hollow form, the content to be discharged by way of forward discharge door 15. Rearward of compactor apparatus 10 is arranged auger compactor head 50, including an auger assembly (discussed further below) and a receiving hopper 16 with a generally upward-facing opening.

As illustrated in FIG. 1, the apparatus includes a bin lifter mechanism 18 such that waste material can be discharged from bins 20 into hopper 16 by lifting and inverting the bins.

An alternative form of the apparatus is shown in FIG. 1A, in which the same reference numerals are used to identify the equivalent components. In both embodiments, container 14 is configured to be removable, to be detached from the compactor head 50 of the apparatus when full and transferred by truck as required for subsequent processing steps. The embodiment of FIG. 1A does not feature an integrated bin lifter, the waste material being introduced to hopper 16 by other means.

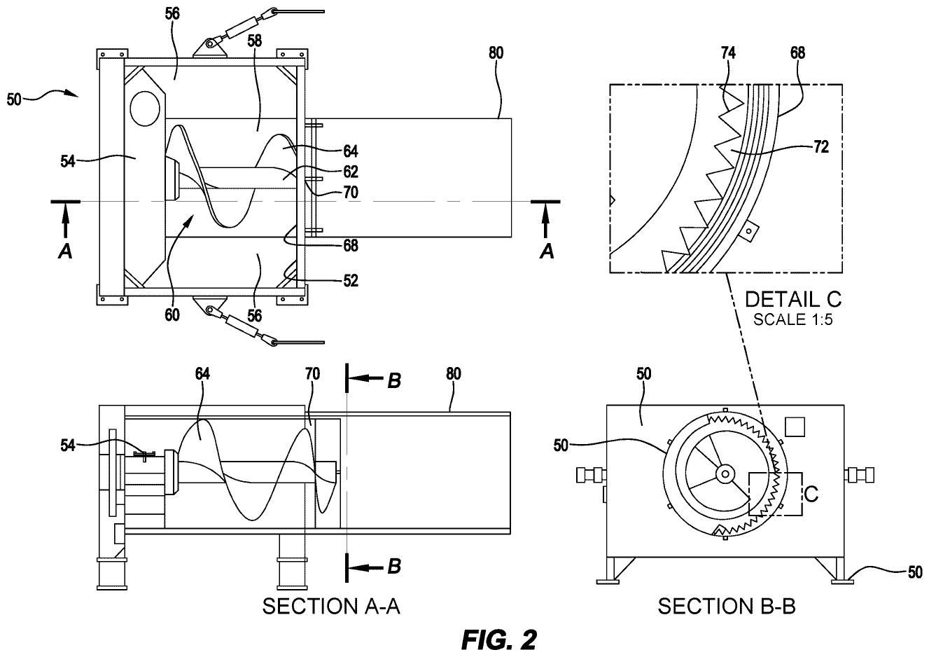

Turning to FIG. 2, auger compactor head 50 defines an auger chamber for containing and processing received waste, defined by a chamber front wall 52, a chamber rear enclosure 54 (housing a drive assembly and defining an chamber rear wall), two inclined planar chamber wall portions 56 and a chamber base part-cylindrical portion 58. The various components are all supported on a compactor head frame 51.

Supported to the chamber rear enclosure 54 and mounted to rotate within the auger chamber is an auger 60, comprising an auger shaft 62—arranged in a generally horizontal direction and extending in the longitudinal direction of the stationary compactor 10—carrying auger screw flighting 64. Auger 60 is disposed in the auger chamber such that the outer edge of flight 64 is adjacent the surface of chamber base part-cylindrical portion 58, such that rotation of auger 60 results in waste in the hopper being pushed in a forward direction. A part of the outer edge of flight 64 is equipped with a plurality of spaced auger teeth 66, discussed in further detail below.

Chamber front wall 52 is provided with a circular outlet opening 68, providing a connection between the auger chamber and the interior of compacted waste receiving container 14. The diameter of outlet opening 68 is a little larger than the outer diameter of auger flight 64, and the auger 60 is positioned concentric with outlet opening 68 and of length sufficient to pass a short distance beyond auger chamber front wall 52 (i.e. through opening 68), as shown in FIG. 2. Auger chamber base part-cylindrical portion 58 is substantially flush with the bottom part of outlet opening 68 so that waste which has fallen into that base portion will be urged towards and through the opening.

Connected to chamber front wall 52 and around outlet opening 68 is an annular flange 70 extending in the longitudinal (ie. axial) direction into the interior of compacted waste receiving container 14, to which is mounted a tubular outlet safety section 80 to minimise as far as possible the risk of access by personnel to auger head 50.

As will be understood, the operation of the auger compactor results in crushing and changing the size and shape of waste items prior to packing the material into a receiving volume defined by the interior of container 14. The auger can be paired with bin lifters, tippers, chutes, conveyors, platforms, pre-crushers, sliders, balers and bins of various different sizes. In common with other augur equipment, the auger compactor can operate continuously (rather than batch-wise), the resulting uninterrupted processing minimising the need for onsite waste storage.

As shown in section B-B and detail C of FIG. 2, outlet opening 68 is provided with a number of arcuate fixed tooth sections 72, each providing a plurality of fixed teeth 74, each tooth generally inwardly directed (i.e. towards the centreline of the auger).

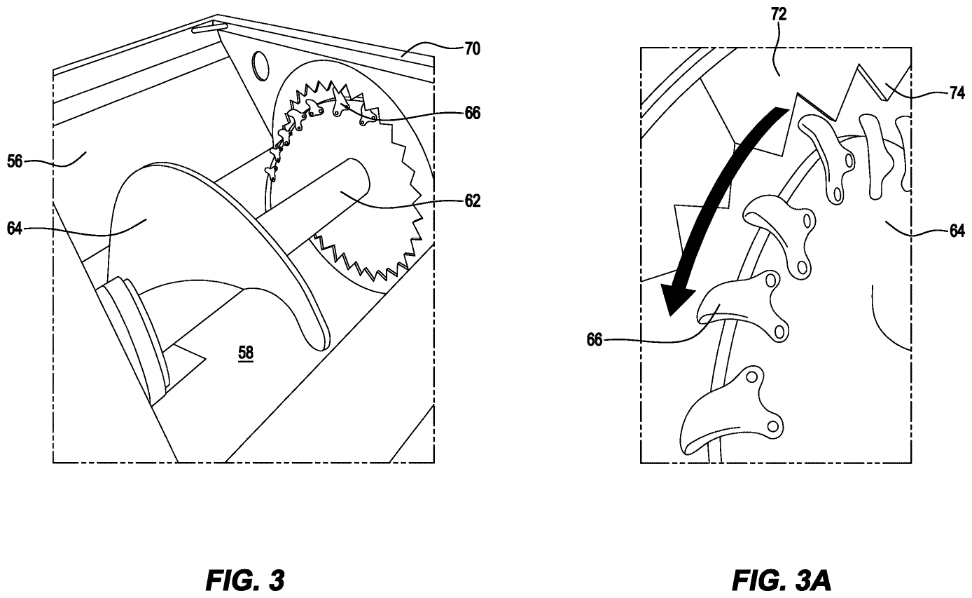

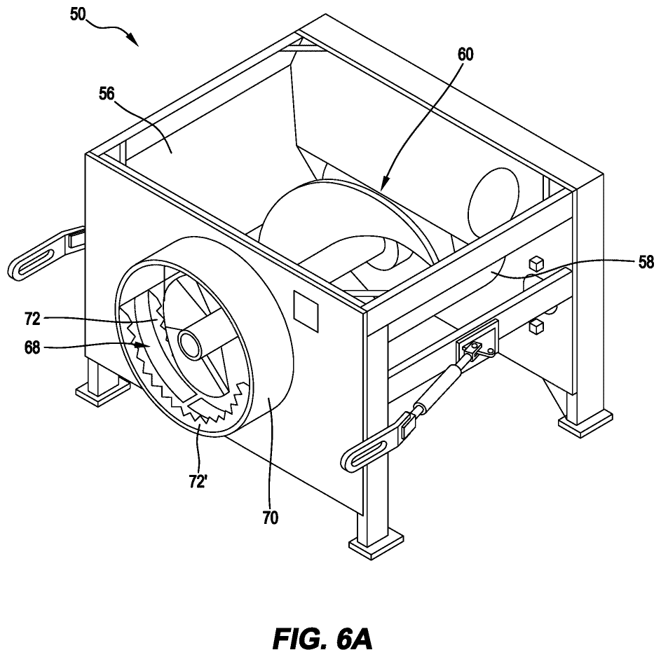

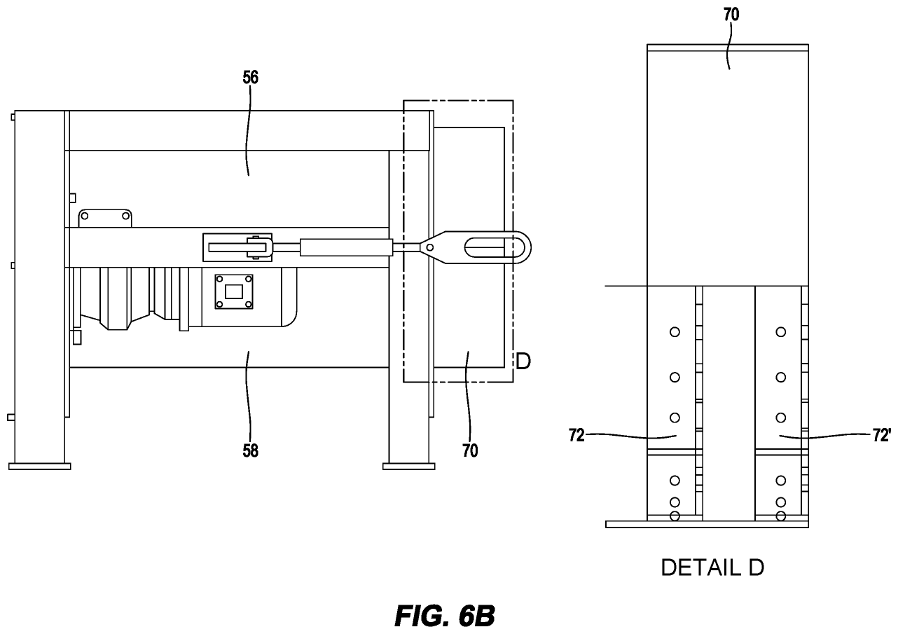

Tooth sections 72 may be arranged around opening 68 (for example, welded or bolted thereto) to cover the full peripheral extent of the opening (see, for example, the embodiment of FIGS. 3 and 3B), or arranged around opening 68 to only partially cover the peripheral extent of the opening (see, for example, the embodiment of FIGS. 6A and 6B).

As most clearly illustrated in FIG. 3 (with FIG. 3A showing closer detail, also indicating direction of rotation), over a portion of the axial extent of auger 60, being the front part of the auger which passes through outlet opening 68, a plurality of spaced auger teeth 66 are mounted to auger flight 64 to project outwardly from the outer edge thereof, sized and positioned to pass close to the inner extent of fixed teeth 74 where auger 60 passes through outlet opening 68.

With the rotation of auger 60, auger teeth 66 move relative to fixed teeth 74, a clearance being provided between the two set of teeth to avoid clashing (for example, a clearance of around 10 mm). Unlike fixed teeth 74, auger teeth 66 are cutter teeth (eg. with a generally sawtooth shaping) having a leading point, designed to facilitate the snagging, tearing and/or puncturing of waste items they meet. To this end, in the particular apparatus developed and tested by the applicant, the teeth comprise a forward-pointing ‘sharkfin’ shaping comprising a mild steel body and specially hardened tip material. Other suitable materials and shapings are of course possible, depending on the particular application.

Teeth 66 are affixed to auger flight 64 by welding, bolting or other suitable method. In the apparatus tested by the applicant, the auger teeth 66 are mutually spaced by a regular angular separation around auger flight 64, extending over an axial length of around 650 mm to the forward end of the auger.

In operation, waste that has been deposited in hopper 16 to fall into the lower part of the auger compactor will be compacted by auger 60 and driven in a forward direction towards auger chamber front wall 52. As it approaches outlet opening 68 at least a part of the waste stream will be contacted by auger teeth 66, which will start to impinge on waste items. Once the waste items come into contact with fixed teeth 74 they will be subject to a tearing and macerating action as they pass through outlet opening 68, this assisting in the compaction of the waste stream before it is passed to waste receiving container 14. For waste items that have been entrained by auger teeth 66 to rotate therewith, the fixed teeth 74 provide the function of ‘grabbing’ the waste items so that may be shredded by the rotating auger teeth 66 on their next pass.

In particular, large items of cardboard and similar, such as long rigid cardboard cores as used in a variety of industries (such as heavy duty winding cores) will necessarily find themselves between the opposed sets of teeth 66 and 74 as they pass through outlet opening 68, and thus will be torn into shorter lengths, improving compaction significantly. Further, when the waste stream includes plastic bottles and other containers, these can be punctured and torn by the auger and/or fixed teeth as they pass to and through outlet opening 68, similarly improving compaction significantly.

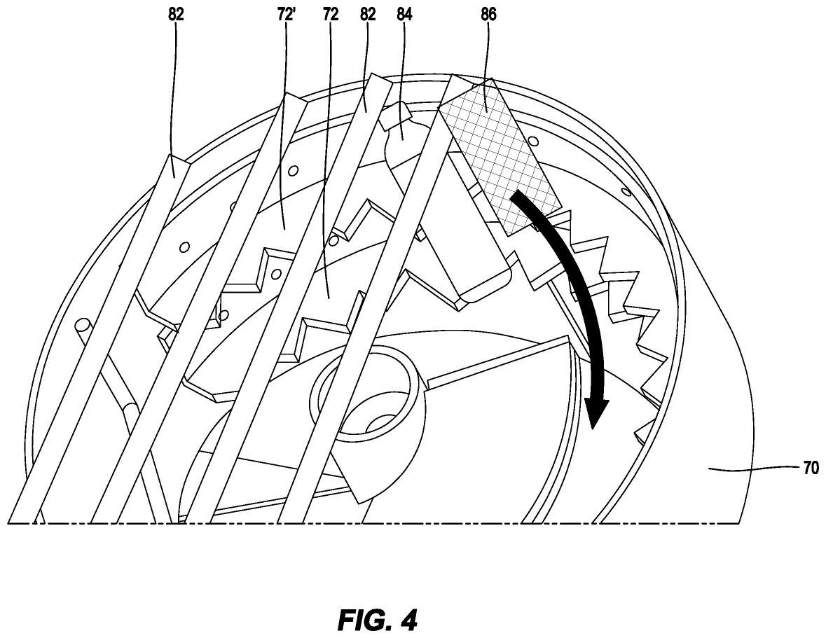

The further embodiment of the stationary compactor 10 shown in FIG. 4 includes additional features of the outlet portion of the auger compactor head 50, to assist in the operation described above.

This embodiment is configured to facilitate compaction of certain bulk waste items, in particular recyclable material such as plastic bottles and cans. Plastic bottles are often introduced into the waste stream with lids secured, making compaction difficult. Such waste items are surprisingly resistant to significant deformation through normal waste processing and compaction. Hence, the ability to puncture or tear such items significantly assists in regard to downstream compaction.

With this mind, in this embodiment a second set of arcuate fixed tooth sections 72′ is included, axially spaced from sections 72 in the forward direction. This therefore provides a second plurality of fixed teeth spaced from the first plurality of fixed teeth 74 and of a similar form thereto. In this embodiment the axial dimension of annular flange 70 is increased to accommodate the second set of arcuate fixed tooth sections 72′. The separation of the two sets of teeth is selected to be somewhat less than the length of a small plastic bottle (such as a 600 ml bottle) 84, and this arrangement has the effect of increasing the tearing action (or increasing the likelihood of that tearing action happening) on items of waste that pass through outlet opening 68.

As noted above, it is not necessary that either set of fixed teeth encompass the entire circumference of outlet opening 68, arcuate fixed tooth sections 72, 72′ being selected and positioned as desired around outlet opening 68 and/or annular flange 70.

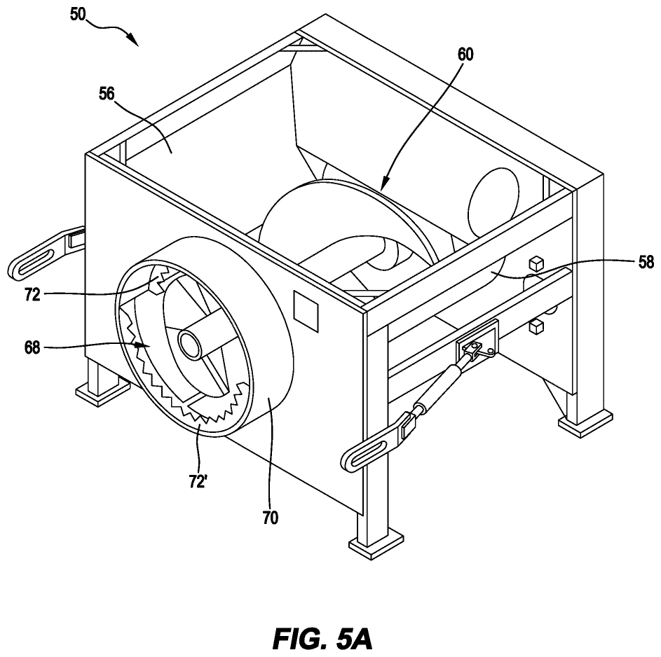

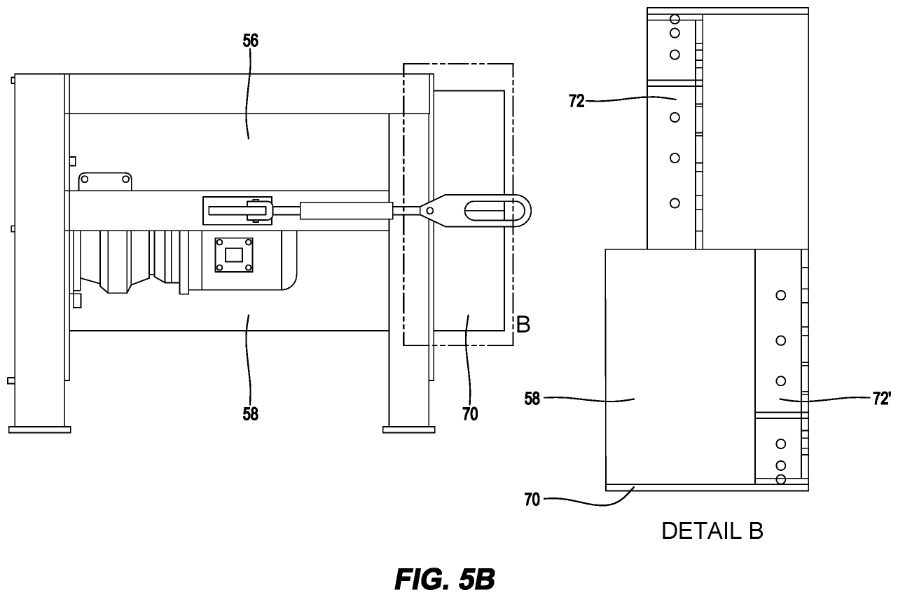

For example, the embodiment depicted in FIG. 5A and FIG. 5B includes a set of arcuate fixed tooth sections 72 arranged around the upper half of the circular outlet opening 68 and a second set of arcuate fixed tooth sections 72′ arranged around the lower half of the annular flange 70, which together cover the full 360° of the circumferential extent of outlet opening 68. Testing by the applicant has shown this embodiment to be particularly beneficial to the compaction rate of plastic bottles and similar.

In a further example, the embodiment depicted in FIG. 6A and FIG. 6B includes a first set of arcuate fixed tooth sections 72 arranged around the lower half of the circular outlet opening 68 and a second set of arcuate fixed tooth sections 72′ arranged around the lower half of the annular flange 70.

In the latter two embodiments, the second set of arcuate fixed tooth sections 72′ is axially spaced from the first set of arcuate fixed tooth sections 72 (as shown in FIGS. 5A and 6A).

As shown in FIG. 4, in a further embodiment multiple spaced horizontal strainer bars 82 are mounted (e.g. by welding) to the forward end of annular flange 70, bars 82 sized and arranged to assist in retaining items for impacting by the action of the auger and fixed teeth. Deformed or shredded bottles and cans are able to pass between strainer bars 82, while intact ones are retained so that a subsequent rotation of auger teeth 66 passing close to fixed teeth 74 can result in puncturing and/or deforming those items. Further, additional steel plate 86 is affixed (e.g. by welding) to the internal face of annular flange 70, downstream of second set of arcuate fixed tooth sections 72′. This acts as a stop, restraining rotational movement of individual items until they are impacted by a subsequent pass of auger teeth 66.

Steel plate (or other stop) 86 may be provided by or attached to one or more of the strainer bars 82, for example at a radially outward part thereof.

The auger 60 is driven by an electric motor via a chain and geared drive, part of which may be provided within chamber rear enclosure 54, with the motor mounted to the frame of the compactor head external of the auger chamber. The auger head and the waste compactor can be designed and built in different sizes and variants to suit the particular waste stream and site-specific requirements.

As will be understood, the shape, size, pitch and positioning of the respective sets of teeth 66 and 74 can be varied to suit the particular application.

Various alternatives and additional to the details described above can be employed, depending on particular applications. For example, the stationary compactor may include an auger compactor head 50 with twin augers (with two parallel auger shafts) and twin outlet openings, each auger and each opening equipped with set of moving and fixe teeth, respectively. This may be suitable for heavy duty and high volume waste streams.

It will be understood that the invention disclosed and defined in this specification extends to all alternative combinations of two or more of the individual features mentioned or evident from the text or drawings. All of these different combinations constitute various alternative aspects of the invention.

1. A bulk waste compaction apparatus including a material-receiving hopper, an elongated trough, and an auger mounted to rotate in and drive material axially lengthwise of the elongated trough, including an opening through which the material is driven forward by the auger, wherein the auger includes an auger flight,
the auger flight having a plurality of auger teeth projecting radially outwardly therefrom and
a plurality of fixed teeth provided at or adjacent to the opening and projecting radially inwardly towards the auger.

2. The bulk waste compaction apparatus of claim 1, wherein the auger extends through the opening and the auger teeth are disposed on the auger flight for at least an axial distance both forward and rearward of the opening.

3. The bulk waste compaction apparatus of claim 1 or claim 2, wherein both the opening and the auger flight when viewed in transverse projection are both circular, their respective diameters resulting in the fixed teeth and the auger teeth passing relatively close to one another as the auger rotates.

4. The bulk waste compaction apparatus of any one of the preceding claims, wherein the elongated trough is shaped to direct introduced waste material to and contain said material in a part of the trough adjacent to the auger flight.

5. The bulk waste compaction apparatus of any one of the preceding claims, wherein the auger teeth are cutter teeth, each tooth having a generally sawtooth shaping, an acute edge and/or a leading point.

6. The bulk waste compaction apparatus of any one of the preceding claims, wherein the fixed teeth are provided on arcuate fixed tooth sections, each section providing a number of fixed teeth.

7. The bulk waste compaction apparatus of claim 6, wherein multiple arcuate fixed tooth sections are mounted to the apparatus to partially or wholly encompass the circumference of the opening.

8. The bulk waste compaction apparatus of any one of the preceding claims, including a further plurality of fixed teeth axially spaced from the plurality of fixed teeth.

9. The bulk waste compaction apparatus of any one of the preceding claims, including one or more retention elements adjacent to or downstream of the fixed teeth and mounted to restrain the axial and/or rotational movement of waste material.

10. The bulk waste compaction apparatus of claim 9, wherein the one or more retention elements increase the likelihood of the waste material being impacted between the auger teeth and the fixed teeth.

11. The bulk waste compaction apparatus of any one of the preceding claims, including one or more strainer elements provided beyond and adjacent to the downstream extent of the auger.

12. The bulk waste compaction apparatus of claim 11, wherein the one or more strainer elements are configured to retain waste items greater than a certain size.

13. The bulk waste compaction apparatus of any one of the preceding claims, including one or more radially extending retainer elements configured to retain waste material against rotation.

14. The bulk waste compaction apparatus of any one of the preceding claims, including a bulk waste container to receive material that has been impacted by the interaction between the auger teeth and the fixed teeth.

15. The bulk waste compaction apparatus of claim 14, wherein the bulk waste container is separable from the rest of the apparatus.
